(19) United States
(12) Patent Application Publication
(10) Pub. No.: US 2020/0280690 A1
(43) Pub. Date: Sep. 3, 2020

(54) METHOD FOR DRIVING IMAGING APPARATUS

(71) Applicant: CANON KABUSHIKI KAISHA, Tokyo (JP)

(72) Inventors: Hisashi Takado, Kawasaki-shi (JP); Noriyuki Kaifu, Atsugi-shi (JP); Yasushi Iwakura, Kawaguchi-shi (JP); Masaaki Minowa, Kawasaki-shi (JP); Takeshi Akiyama, Ebina-shi (JP); Toshiki Tsuboi, Tokyo (JP)

(21) Appl. No.: 16/877,285

(22) Filed: May 18, 2020

Related U.S. Application Data
(62) Division of application No. 15/994,728, filed on May 31, 2018.
Application No. 15/994,728 is a continuation of application No. PCT/JP2016/085705, filed on Dec. 1, 2016.

(30) Foreign Application Priority Data
Dec. 4, 2015 (JP) 2015-237866

(51) Int. Cl. H04N 5/359; H04N 5/353; H04N 5/355; H04N 5/3745

(52) U.S. Cl. CPC H04N 5/3597; H04N 5/3535; H04N 5/2357; H04N 5/37452; H04N 5/35554

(57) ABSTRACT

A charge generated in a single photoelectric conversion unit during a certain period is stored in a first charge storing unit, and a charge generated in the single photoelectric conversion unit during a different period is stored in a second charge storing unit, and then a third transferring unit is set to on-state to transfer the charge to a floating diffusion, and then, in a state where the charge transferred to the floating diffusion is stored, a fourth transferring unit is set to on-state.

### CROSS-REFERENCE TO RELATED APPLICATIONS

This application is a Divisional of U.S. patent application Ser. No. 15/994,728, which was filed on May 31, 2018 and which is a Continuation of International Patent Application No. PCT/JP2016/085705, which was filed on Dec. 1, 2016 and which claims priority to Japanese Patent Application No. 2015-237866, which was filed on Dec. 4, 2015, all of which are hereby incorporated by reference herein in their entireties.

### TECHNICAL FIELD

The present invention relates to a method for driving an imaging apparatus.

### BACKGROUND ART

A plurality of memories that store signals that are output from pixels are provided in an imaging apparatus disclosed in PTL 1.

Each memory stores a signal that is output from a pixel corresponding to a charge generated in a photoelectric conversion unit that is continuously irradiated with light.

The charge generated in the photoelectric conversion unit is converted into a voltage by a source follower circuit and is then stored in the memory.

In addition, the signal that is converted into a voltage and stored is subjected to addition or averaging processing in the following-stage circuit so as to expand the dynamic range.

### CITATION LIST

### Patent Literature

PTL 1 Japanese Patent Laid-Open No. 2013-55610

In a configuration in which each of a plurality of memories stores a signal that is output from a pixel corresponding to a charge generated in a photoelectric conversion unit, the charge generated in the photoelectric conversion unit in a pixel is converted into a voltage and is then stored as a signal. Each stored signal may include a noise in a source follower.

In particular, in a case of using signals based on charges generated during different periods among charges generated in the photoelectric conversion unit, since signals generated during different periods are used, there is a high possibility of variation as a result of further temporal change of the noise.

Accordingly, a research has been required for increasing an S/N ratio (signal/noise ratio) at the time of adding the stored signals.

In view of the above problem, the present invention provides a method for driving an imaging apparatus that can increase the S/N ratio when generating an image by using charges generated in a photoelectric conversion unit during different periods.

### SUMMARY

The present invention provides a method for driving an imaging apparatus including a plurality of pixels in a matrix, the pixels each including, a photoelectric conversion unit, at least two charge storing units configured to store a charge generated in the single photoelectric conversion unit, a first transferring unit configured to transfer a charge generated in the single photoelectric conversion unit from the single photoelectric conversion unit to a first charge storing unit among the first charge storing unit and a second charge storing unit, a second transferring unit configured to transfer a charge generated in the single photoelectric conversion unit from the single photoelectric conversion unit to the second charge storing unit, a floating diffusion to which the charge stored in the first charge storing unit and the charge stored in the second charge storing unit are transferred, a third transferring unit configured to transfer the charge from the first charge storing unit to the floating diffusion, and a fourth transferring unit configured to transfer the charge from the second charge storing unit to the floating diffusion. The method includes causing the first charge storing unit to store a charge generated in the single photoelectric conversion unit during a certain period and the second charge storing unit to store a charge generated in the single photoelectric conversion unit during a different period, and then setting the third transferring unit to on-state to transfer the charge to the floating diffusion, and then, in a state where the transferred charge is stored in the floating diffusion, setting the fourth transferring unit to on-state.

Further features of the present invention will become apparent from the following description of exemplary embodiments with reference to the attached drawings.

### BRIEF DESCRIPTION OF DRAWINGS

FIG. 1 is a block diagram of an imaging apparatus.

FIG. 2 is a circuit diagram of pixels.

FIG. 3 is a driving conceptual diagram.

FIGS. 4A and 4B are driving pulse diagrams.

FIG. 5 is a circuit diagram of pixels.

FIG. 6 is a driving conceptual diagram.

FIG. 7 is a driving pulse diagram.

FIG. 8 is a driving conceptual diagram.

FIG. 9 is a driving pulse diagram.

FIG. 10 is a driving conceptual diagram.

FIGS. 11A and 11B are driving pulse diagrams.

FIG. 12 is a driving conceptual diagram.

### DESCRIPTION OF EMBODIMENTS

### First Embodiment

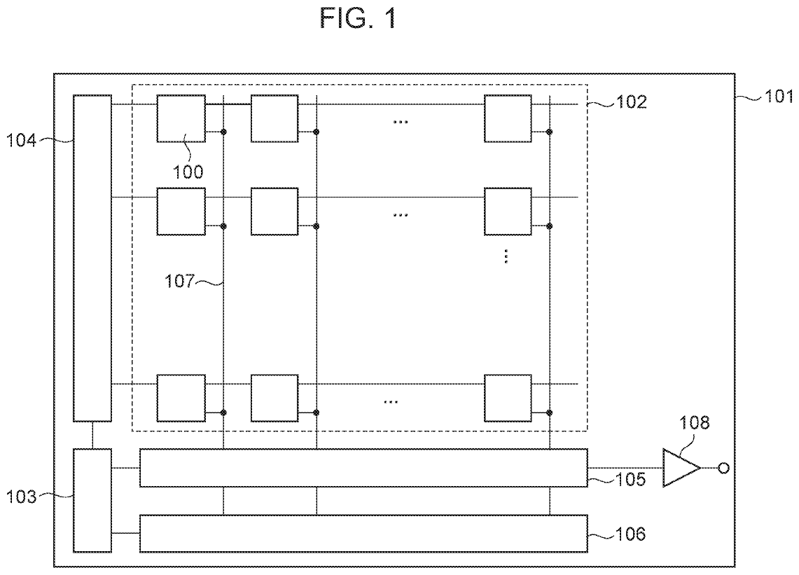

A method for driving an imaging apparatus according to this embodiment will be described with reference to FIGS. 1 to 4. Parts denoted by the same reference numerals in the drawings indicate the same elements or the same regions.

FIG. 1 illustrates a block diagram of an imaging apparatus 101. The imaging apparatus 101 includes a pixel unit 102, a pulse generating unit 103, a vertical scanning circuit 104, a column circuit 105, a horizontal scanning circuit 106, signal lines 107, and an output circuit 108.

The pixel unit 102 includes, on an imaging plane, a plurality of pixels 100 each of which converts light into an electric signal and outputs the converted electric signal. The plurality of pixels 100 are arranged in a matrix.

The vertical scanning circuit 104 receives a control pulse from the pulse generating unit 103 and supplies a driving pulse to each pixel.

For the vertical scanning circuit 104, a logical circuit such as a shift register or an address decoder is used.

Each of the signal lines 107 is arranged in a corresponding pixel column of the pixel unit 102, and signals from the pixels are output to the signal lines 107.

The column circuit 105 receives output in parallel via the signal lines 107 and performs predetermined processing. The predetermined processing is at least one of noise removal, signal amplification, and AD conversion.

The horizontal scanning circuit 106 supplies, to the column circuit 105, a driving pulse for sequentially outputting signals subjected to processing performed by the column circuit 105.

The output circuit 108 is configured from a buffer amplifier, a differential amplifier, or the like, and outputs pixel signals from the column circuit 105 to a signal processing unit, which is outside the imaging apparatus 101.

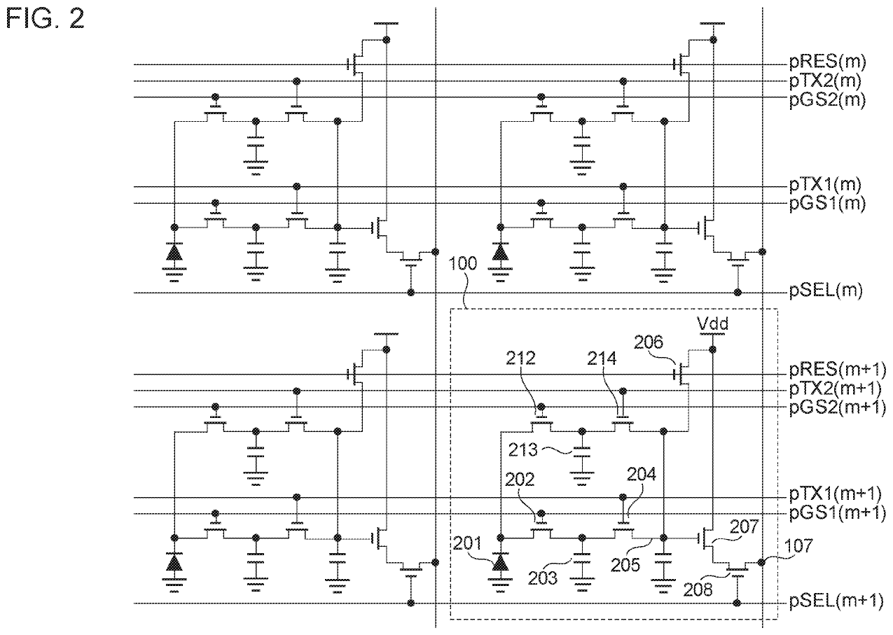

FIG. 2 illustrates a circuit diagram of the pixels 100. In FIG. 2, four pixels 100 in two rows and two columns are illustrated from among the plurality of pixels 100 arranged in a matrix.

In this embodiment, electrons are treated as a signal charge (hereinafter also referred to as charge).

In the following description, each transistor is an N-type transistor.

In a case in which the charge is holes, a semiconductor region in each of a photoelectric conversion unit 201, a charge storing unit, and a floating diffusion (hereinafter FD) 205 has the opposite conductivity type.

Each pixel includes two charge storing units each of which stores a charge generated in the single photoelectric conversion unit. To distinguish the two charge storing units from each other, one of the charge storing units will be referred to as a first charge storing unit, and the other charge storing unit will be referred to as a second charge storing unit in the following description.

With incident light, electron-hole pairs are generated, and electrons are accumulated in the photoelectric conversion unit 201. In this example, a photodiode is illustrated as an example of the photoelectric conversion unit 201.

A first charge storing unit 203 and a second charge storing unit 213 store a charge transferred from the photoelectric conversion unit 201.

A first transferring unit 202 transfers a charge generated in the photoelectric conversion unit 201 to the first charge storing unit 203. A driving pulse pGS1 is supplied to the first transferring unit 202 to switch between on-state (conductive) and off-state (non-conductive) of the first transferring unit 202 by using the driving pulse pGS1.

Specifically, in response to the driving pulse pGS1 being set at a High level (hereinafter referred to as H level), the first transferring unit 202 is set to on-state. In addition, in response to the driving pulse pGS1 being set at a Low level (hereinafter referred to as L level) or less, the first transferring unit 202 is set to off-state.

A second transferring unit 212 transfers a charge generated in the photoelectric conversion unit 201 to the second charge storing unit 213. A driving pulse pGS2 is supplied to the second transferring unit 212 to switch between on-state and off-state of the second transferring unit 212 by using the driving pulse pGS2.

A third transferring unit 204 transfers the charge stored in the first charge storing unit 203 to the FD 205. A driving pulse pTX1 is supplied to the third transferring unit 204 to switch between on-state and off-state of the third transferring unit 204 by using the driving pulse pTX1.

A fourth transferring unit 214 transfers the charge stored in the second charge storing unit 213 to the FD 205. A driving pulse pTX2 is supplied to the fourth transferring unit 214 to switch between on-state and off-state of the fourth transferring unit 214 by using the driving pulse pTX2. Each of the transferring units can be configured from a transistor.

The FD 205 is a semiconductor region to which the charges in the charge storing units are transferred by using the third transferring unit 204 and the fourth transferring unit 214. The FD 205 stores the charges for a predetermined period. In addition, the FD 205 is connected to a gate of an amplifier transistor 207 to be included in a part of an input node of the amplifier transistor 207.

The amplifier transistor 207 forms a source follower and amplifies a signal based on a charge transferred to the FD 205 to output the signal to a signal line 107 through a selection transistor 208.

A drain of the amplifier transistor 207 is connected to a power source wire to which a power source voltage VDD is supplied. A source of the amplifier transistor 207 is connected to a drain of the selection transistor 208, and a source of the selection transistor 208 is connected to the signal line 107.

A reset transistor 206 resets the voltage at the input node including the FD 205.

A driving pulse pRES is supplied to a gate of the reset transistor 206.

In response to the driving pulse pRES being set at H level, on-state is set; in response to the driving pulse pRES being set at L level, off-state is set.

The selection transistor 208 controls electric conduction between the amplifier transistor 207 and the signal line 107 and causes each of the plurality of pixels 100 or the plurality of pixels 100, which are provided for each signal line 107, to output a signal or signals to the signal line 107. A driving pulse pSEL is supplied to a gate of the selection transistor 208.

In response to the driving pulse pSEL being set at H level, on-state is set; in response to the driving pulse pSEL being set at L level, off-state is set.

Instead of the configuration according to this embodiment, without providing the selection transistor 208, by switching the potential at the drain of the amplifier transistor 207 or the gate of the amplifier transistor 207, a selected state and a non-selected state of the signal line 107 may be switched.

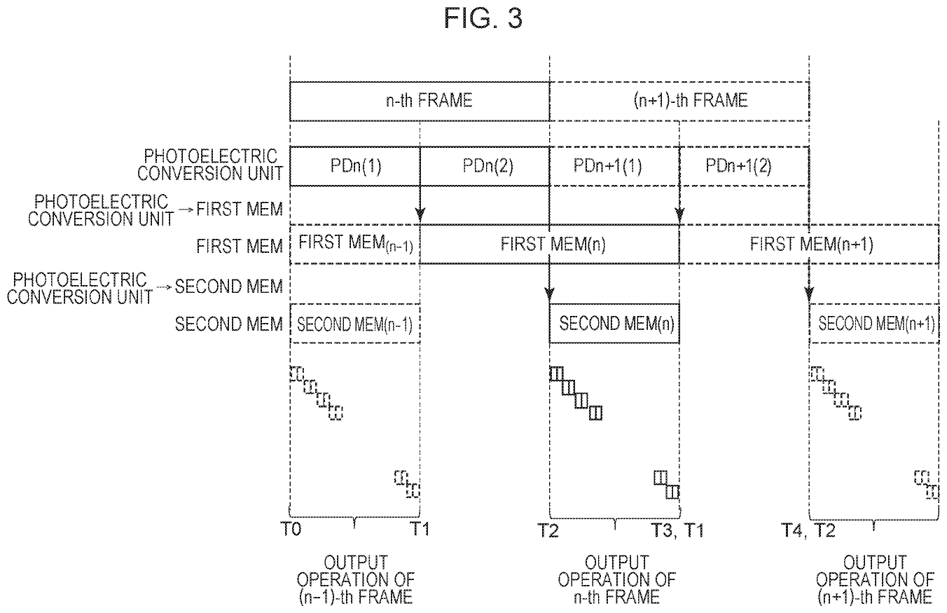

With reference to FIG. 3, the following description will illustrate a temporal change of the transfer and storage of a charge generated in the photoelectric conversion unit of the imaging apparatus according to this embodiment, and the state where a signal is read.

In the drawing, each of the charge storing units is represented as a MEM. The same applies to the following drawings.

The following description will illustrate a global electronic shutter operation in which charge generation is simultaneously started in the photoelectric conversion units 201 in a plurality of pixel rows, i.e., in a plurality of pixels arranged in a matrix, and in which a charge is simultaneously transferred from the photoelectric conversion units 201 to the charge storing units.

Note that this technique is also applicable to a rolling shutter operation in which the start of charge accumulation in the photoelectric conversion units 201 in each of the pixel rows and the transfer of a charge from the photoelectric conversion units 201 to the charge storing units are sequentially performed.

Further, this technique is also applicable to a mechanical shutter operation, in which case, a non-exposure period is provided between frames (e.g., between an n-th frame and an (n+1)-th frame in FIG. 3).

The same also applies to embodiments other than this embodiment.

In addition, each frame in the following drawings and description is a period corresponding to a frame at the time of imaging of a moving image by using images of a plurality of frames.

That is, for example, in a case of imaging at 60 frames in a second, each frame has a length of 1/60 seconds. Similarly, in a case of imaging of a still image, each frame has a length corresponding to a value obtained by dividing a predetermined period by the number of images obtained through imaging.

For example, in a case of imaging at 10 frames in a second, each frame has a length of 1/10 seconds.

As a start time and an end time of a period corresponding to each frame, the following examples will be given.

In a first example, the start time is the time at which the reset of the photoelectric conversion unit is canceled so as to enable charge accumulation in the photoelectric conversion unit, and the end time is the time at which the reset of the photoelectric conversion unit in the following frame is canceled so as to enable charge accumulation in the photoelectric conversion unit.

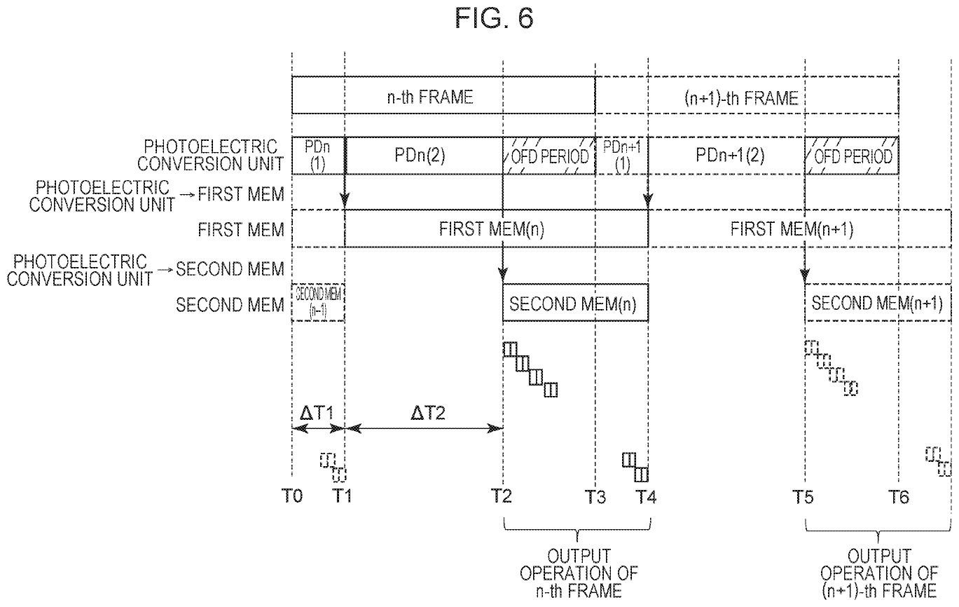

This example corresponds to, for example, the operation in FIG. 6 described later.

In a second example, the start time is the time at which the photoelectric conversion unit in the preceding frame starts charge transfer, and the end time is the time at which the transfer of a charge for generating the image of the frame is started. This example corresponds to, for example, the operations in FIGS. 3, 8, 10, and 12 described later.

Note that the start times and the end times in these examples may be combined with each other.

Although these are specific examples, the accumulation period of the photoelectric conversion unit may be flexibly changed by using overflow drain (OFD) in each of the embodiments.

In such a case, the start time and the end time may be set at any time between the time at which charge transfer from the photoelectric conversion unit in the preceding frame is completed and the time at which the reset of the photoelectric conversion unit is canceled.

FIG. 3 is a conceptual diagram illustrating a charge generated in the photoelectric conversion unit, charges stored in the charge storing units, and output operations thereof.

An arrow represents a timing of transfer from the photoelectric conversion unit to the first charge storing unit.

Another arrow represents a timing of transfer from the photoelectric conversion unit to the second charge storing unit.

In FIG. 3, operations for generating an n-th frame image are illustrated in thick lines, and operations for generating the other frame images are illustrated in dotted lines.

The operations corresponding to the n-th frame will be mainly described in this embodiment.

In FIG. 3, Period T0-T2 is a period corresponding to the n-th frame image, and Period T2-T4 is a period corresponding to an (n+1)-th frame image.

At Time T0, the period corresponding to the n-th frame starts. At Time T0, accumulation of a charge generated in the photoelectric conversion unit 201 is started.

At this time, the first charge storing unit 203 stores a charge (PDn−1(1)) for generating an (n−1)-th frame image, and the second charge storing unit 213 stores a charge (PDn−1(2)) for generating the (n−1)-th frame image.

During Period T0-T1, signals corresponding to the charges stored in the charge storing units in pixels in each pixel row are output sequentially in each row.

At Time T1, a charge PDn(1) generated in the photoelectric conversion unit 201 during Period T0-T1 is transferred to the first charge storing unit 203 in all the pixels at a time.

Then, accumulation of a charge generated in the photoelectric conversion unit 201 for which the charge transfer has been completed is started.

At Time T2, a charge PDn(2) generated in the photoelectric conversion unit 201 during Period T1-T2 is transferred to the second charge storing unit 213 in all the pixels at a time.

Note that the above transfer is performed in the state where the charge PDn(1) transferred at Time T1 is stored in the first charge storing unit 203.

In addition, the transfer of charge for generating the n-th frame image is completed at Time T2.

Accordingly, at Time T2, the period corresponding to the (n+1)-th frame starts, and accumulation of a charge generated in the photoelectric conversion unit 201 is started.

Note that, during Period T2-T3, signals corresponding to the charges PDn(1) and PDn(2) stored in the respective charge storing units are transferred to the FD 205 sequentially in each row and output to the outside of the pixel.

That is, in this embodiment, charges generated in the single photoelectric conversion unit during different periods are stored in the respective two charge storing units, and then, the charges stored in the respective two charge storing units are added in the FD 205.

Here, the FD 205 adds both the charge generated in the photoelectric conversion unit during Period T0-T1 and the charge generated during Period T1-T2 in the FD 205. This enables addition of charges stored without noise in a source follower and an increase in the S/N ratio.

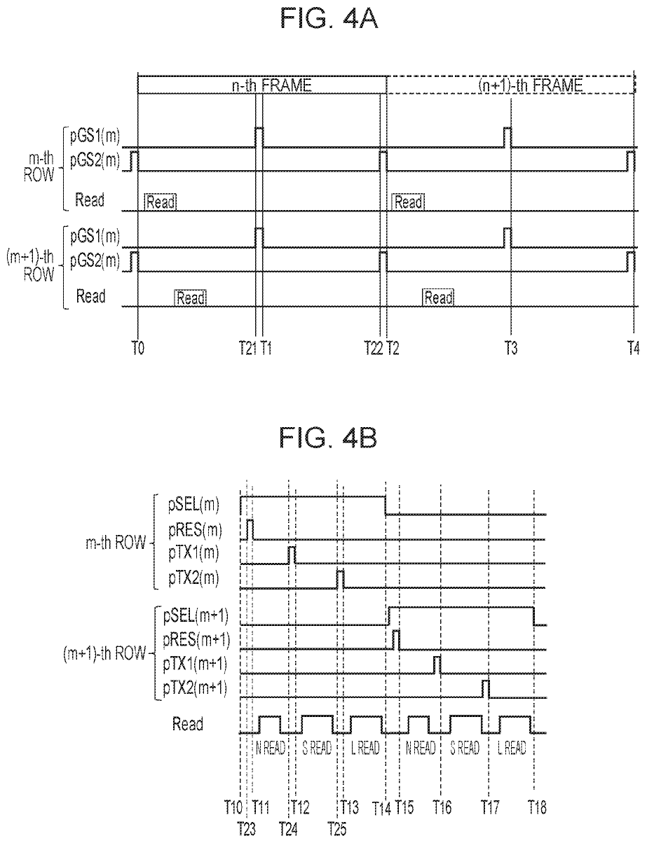

FIGS. 4A and 4B illustrate driving pulse diagrams according to this embodiment. In the description of the driving pulse diagrams in FIGS. 4A and 4B, (m) is added to the tail of the driving pulse name to be supplied to pixels 100 in an m-th row, and (m+1) is added to the tail of the driving pulse name to be supplied to pixels 100 in an (m+1)-th row.

The description will be given with nothing added to the tails of the driving pulse names unless the rows are distinguished from each other.

In addition, parts using the same reference numerals as the reference numerals indicating times in FIG. 3 indicate the same times.

In FIG. 4A, at Time T0, in response to the driving pulse pGS2 being set at L level, the second transferring unit 212 is set to off-state, and accumulation of a charge generated in the photoelectric conversion unit 201 is started.

During Period T0-T1, the charge generated in the photoelectric conversion unit 201 is accumulated. At the same time, an operation for outputting a signal for generating the (n−1)-th frame image is performed.

At Time T21, the driving pulse pGS1 is set at H level, and the first transferring unit 202 is set to on-state. At time T1, the driving pulse pGS1 is set at L level, and the first transferring unit 202 is set to off-state.

During Period T21-T1, the charge PDn(1) generated in the photoelectric conversion unit 201 during Period T0-T1 is transferred to the first charge storing unit 203.

At Time T22, the driving pulse pGS2 is set at H level, and the second transferring unit 212 is set to on-state. At time T2, the driving pulse pGS2 is set at L level, and the second transferring unit 212 is set to off-state.

During Period T22-T2, the charge PDn(2) generated in the photoelectric conversion unit 201 during Period T1-T2 is transferred to the second charge storing unit 213.

Thus, the period corresponding to the n-th frame ends.

Subsequently, a period corresponding to the (n+1)-th frame starts at Time T2.

Note that, during Period T2-T3, accumulation of a charge generated in the photoelectric conversion unit 201 is started. At the same time, an operation for outputting a signal for generating the n-th frame image is performed.

Note that, at Time T2 and Time T3, an operation corresponding to Time T0 and an operation corresponding to Time T1 are performed, respectively.

In this embodiment, the length of Period T0-T1 (ΔT1) and the length of Period T1-T2 (ΔT2) are equal to each other.

A specific output operation (first output operation) in “Read” in FIG. 4A will be described with reference to FIG. 4B.

In FIG. 4B, at Time T10, a driving pulse pSEL(m) supplied to the selection transistors 208 of pixels in the m-th pixel row is set at H level, and the selection transistors 208 are set to on-state.

From Time T10, the first output operation in the m-th row is started. Note that the row in which the selection transistors 208 are sequentially set to on-state is referred to as a selected row.

Subsequently, at Time T23, a driving pulse pRES(m) is set at H level, and the reset transistors 206 are set to on-state. At Time T11, the driving pulse pRES(m) is set at L level, and the reset transistors 206 are set to off-state. During Period T23-T11, a reset operation for discharging a charge that is present in the FDs 205 to a power source Vdd is performed.

Subsequently, during Period T11-T24, a noise signal generated through the reset operation is output to the column circuit 105 in FIG. 1 to be stored therein (N read).

At Time T24, a driving pulse pTX1(m) is set at H level, and the third transferring units 204 are set to on-state. At Time T12, the driving pulse pTX1(m) is set at L level, and the third transferring units 204 are set to off-state.

During Period T24-T12, the charge PDn(1) for generating the n-th frame image, the charge being stored in the first charge storing units 203, is transferred to the FDs 205.

Subsequently, during Period T12-T25, a signal corresponding to the charge PDn(1) transferred to the FDs 205 is amplified through a source follower operation of the amplifier transistors 207, and is output to the column circuit 105 to be stored therein (S read).

Subsequently, at Time T25, a driving pulse pTX2(m) is set at H level, and the fourth transferring units 214 are set to on-state. At Time T13, the driving pulse pTX2(m) is set at L level, and the fourth transferring units 214 are set to off-state.

During Period T25-T13, the charge (PDn(2)) for generating the n-th frame image, the charge being stored in the second charge storing units 213, is transferred to the FDs 205.

Note that the FDs 205 are not reset during Period T12-T13.

Accordingly, a charge obtained by adding the charge PDn(1) and the charge PDn(2) is stored in the FDs 205.

During Period T13-T14, a signal corresponding to the charge obtained by adding the charge PDn(1) and the charge PDn(2) transferred to the FDs 205 is amplified through a source follower operation of the amplifier transistors 207 and is output to the column circuit 105 to be stored therein (L read).

Subsequently, at Time T14, the driving pulse pSEL(m) is set at L level, and off-state is set.

Thus, selection of the m-th row is completed.

In the subsequent processing, the first output operation is performed sequentially in each row.

In this embodiment, the charge PDn(1) stored in the first charge storing unit 203 is transferred to the FD 205, and a signal corresponding to the charge PDn(1) is output to the column circuit 105 to be stored therein.

Subsequently, the charge PDn(2) stored in the second charge storing unit 213 is transferred to the FD 205, and a signal corresponding to a charge obtained by adding the charge PDn(1) and the charge PDn(2) is output to the column circuit 105 to be stored therein.

Thus, it is possible to obtain a signal corresponding to the charge for which the accumulation period of the photoelectric conversion unit 201 is Period ΔT1 and a signal corresponding to the charge for which the accumulation period is two times as long as Period ΔT1.

Note that at least a part of the period during which the third transferring unit is set to on-state and at least a part of the period during which the fourth transferring unit is set to on-state may be overlapped with each other.

The same applies to the following embodiments.

In addition, the signal corresponding to Period ΔT1 is treated as a signal corresponding to a charge for which the accumulation period is short (short accumulation period), and the signal obtained through addition is treated as a signal corresponding to a charge for which the accumulation period is long (long accumulation period). This can expand the dynamic range.

Furthermore, in a case in which the column circuit 105 adds the signal corresponding to the charge PDn(1) and the signal corresponding to the charge PDn(2), since the signals corresponding to the respective charges include random noises in the source follower, and the random noises are added too.

On the other hand, in this embodiment, since the charge PDn(1) and the charge PDn(2) are added in the FD 205, the random noises can be reduced.

This can increase the S/N ratio at a low illuminance.

Furthermore, in a case in which a signal corresponding to the charge PDn(1) in the first charge storing unit 203 and a signal corresponding to the charge PDn(2) in the second charge storing unit 213 are read separately, it is necessary to reset the FD 205 during Period T12-T25.

In this case, however, a noise signal after a reset operation that is performed before charge transfer from the first charge storing unit 203 to the FD 205 and a noise signal after a reset operation that is performed before charge transfer from the second charge storing unit 213 to the FD 205 do not have correlation with the KTC noise after the reset operation.

Accordingly, it is necessary to output each of the noise signals.

On the other hand, in this embodiment, it is unnecessary to reset the FD 205 during Period T12-T25. Accordingly, the noise signal may be read only once. This can reduce an output period for a row and can simplify signal processing in the following-stage circuit.

Although a case in which two charge storing units are provided for the single photoelectric conversion unit 201 has been described as an example in this embodiment, three or more charge storing units may be provided for the single photoelectric conversion unit 201.

The same applies to the following embodiments.

### Second Embodiment

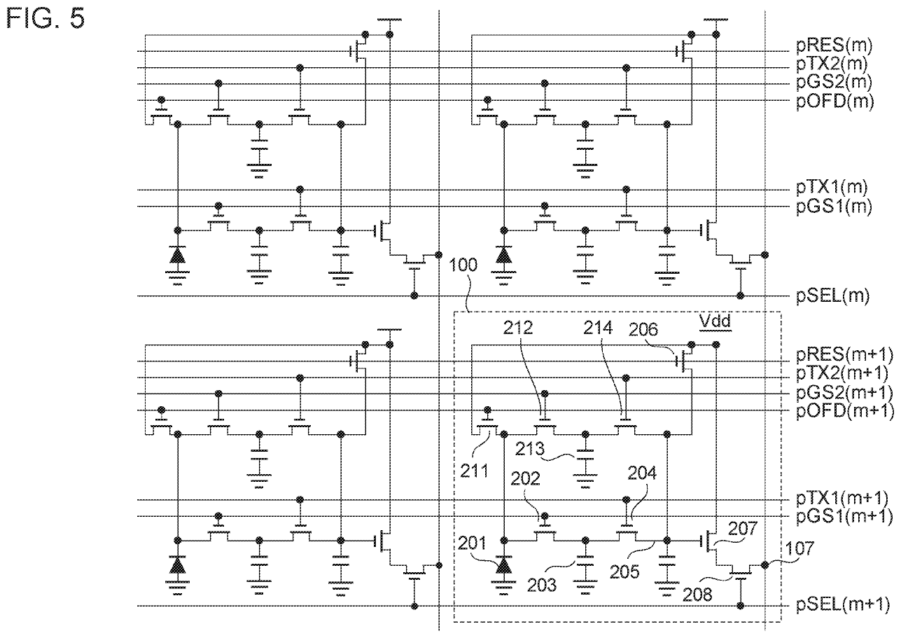

An imaging apparatus according to this embodiment will be described with reference to FIGS. 5 to 7.

This embodiment differs from the first embodiment in that a charge accumulation period of the photoelectric conversion unit 201 for a charge to be stored in the first charge storing unit is shorter than a charge accumulation period of the photoelectric conversion unit 201 for a charge to be stored in the second charge storing unit 213.

That is, in this embodiment, the length of the period during which a charge to be transferred to one of the charge storing units (first charge storing unit) is accumulated in the single photoelectric conversion unit is shorter than the length of the period during which a charge to be transferred to the other charge storing unit (second charge storing unit) is accumulated in the single photoelectric conversion unit.

The following description will be given focusing on the difference from the first embodiment.

Note that although this embodiment will describe a case in which an overflow drain transistor (hereinafter referred to as OFD transistor) that resets a charge in the photoelectric conversion unit is provided, the OFD transistor is not necessarily provided.

FIG. 5 is a circuit diagram of the pixels 100 used in this embodiment. A driving pulse pOFD is supplied to a gate of an OFD transistor 211 to control on-state and off-state.

By setting the OFD transistor 211 to on-state, an unnecessary charge obtained when the photoelectric conversion unit 201 is irradiated with intense light is discharged.

In addition, the OFD transistor 211 can control the accumulation period of the photoelectric conversion unit 201.

With reference to FIG. 6, the following description will illustrate a temporal change of the transfer and storage of a charge generated in the photoelectric conversion unit of an imaging apparatus according to this embodiment, and the state where a signal is read.

Although the generation of a charge in the photoelectric conversion unit is controlled by charge transfer from the photoelectric conversion unit to the charge storing units in the first embodiment, the start of a charge generation period of the photoelectric conversion unit can be controlled to be at any time by using the OFD transistor 211 independently of charge transfer in this embodiment.

In addition, in this embodiment, the length of the accumulation period for a charge to be transferred from the photoelectric conversion unit 201 to the first charge storing unit 203 differs from the length of the accumulation period for a charge to be transferred from the photoelectric conversion unit 201 to the second charge storing unit 213.

FIG. 6 is a conceptual diagram illustrating a charge generated in the photoelectric conversion unit, charges stored in the charge storing units, and output operations thereof.

In FIG. 6, Period T0-T3 is a period corresponding to an n-th frame, and Period T3-T6 is a period corresponding to an (n+1)-th frame.

At Time T0, the OFD transistor 211 is set to off-state from on-state, and generation of a charge for generating an n-th frame image is started in the photoelectric conversion unit 201.

At this time, the first charge storing unit 203 stores a charge PDn−1(1) for generating an (n−1)-th frame image, and the second charge storing unit 213 stores a charge PDn−1(2) for generating the (n−1)-th frame image.

At Time T1, a charge PDn(1) generated in the photoelectric conversion unit 201 during Period T0-T1 is transferred from the photoelectric conversion unit 201 to the first charge storing unit 203 in all the pixels at a time and is stored in the first charge storing unit 203.

At Time T2, a charge PDn(2) generated in the photoelectric conversion unit 201 during Period T1-T2 is transferred from the photoelectric conversion unit 201 to the second charge storing unit 213 in all the pixels at a time and is stored in the second charge storing unit 213.

This transfer is performed in the state where the charge is stored in the first charge storing unit 203.

During Period T2-T3, a charge generated in the photoelectric conversion unit 201 is discharged to the power source Vdd by setting the OFD transistor 211 to on-state.

Hereinafter, an operation for discharging a charge by setting the OFD transistor 211 to on-state will be referred to as an OFD operation.

At Time T3, upon completion of the OFD operation, a period corresponding to an (n+1)-th frame image starts, and accumulation of a charge generated in the photoelectric conversion unit 201 is started.

At Time T4, a charge PDn+1(1) accumulated during Period T3-T4 is transferred to the first charge storing unit 203 in all the pixels at a time.

Signals corresponding to the charge PDn(1) and the charge PDn(2) stored in the respective charge storing units during Period T2-T4 are output sequentially in each row to the outside of the pixel. The above operation is the operation in this embodiment.

The operation in this embodiment is the same as that in the first embodiment in that a charge generated in the single photoelectric conversion unit is transferred to the second charge storing unit 213 in the state where charges generated in the single photoelectric conversion unit during different periods are stored in the first charge storing unit 203.

The difference is the length of the period during which a charge to be transferred through a single transfer operation is accumulated in the photoelectric conversion unit.

Specifically, the period during which a charge to be transferred to the first charge storing unit 203 to be stored therein through a single transfer operation is accumulated in the photoelectric conversion unit is shorter than the period during which a charge to be transferred to the second charge storing unit 213 to be stored therein through a single transfer operation is accumulated in the photoelectric conversion unit.

That is, a relationship where Period T0-T1 (ΔT1)<Period T1-T2 (ΔT2) is satisfied.

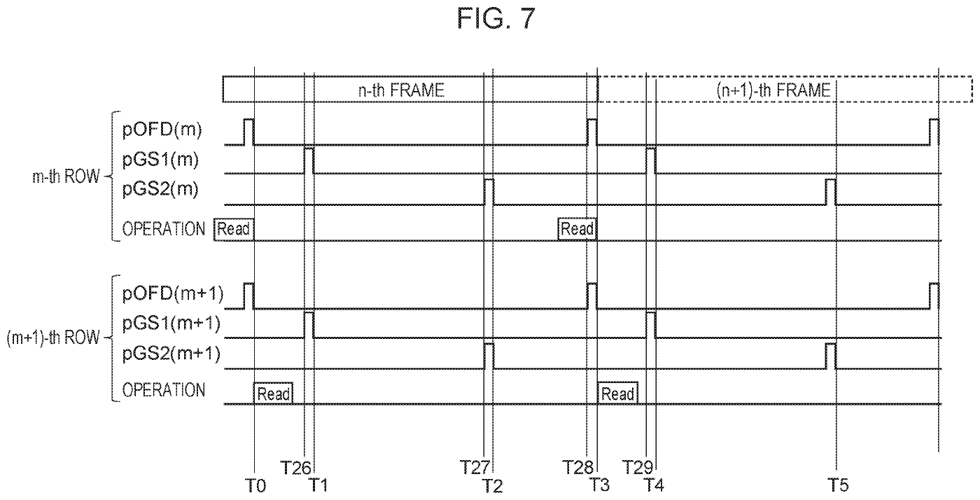

Next, FIG. 7 illustrates a driving pulse diagram based on the concept for driving in FIG. 6.

As illustrated in FIG. 7, at Time T0, in response to the driving pulse pOFD being set to L level from H level, discharging of a charge generated in the photoelectric conversion unit 201 to the power source Vdd is completed, and accumulation of charge for generating the n-th frame image is started.

At Time T26, a driving pulse pGS1 is set at H level, and the first transferring unit 202 is set to on-state. At Time T1, the driving pulse pGS1 is set at L level, and the first transferring unit 202 is set to off-state.

Thus, the transfer of a charge generated in the photoelectric conversion unit 201 during Period T0-T1 to the first charge storing unit 203 in all the pixels at a time is completed.

After Time T1, when the driving pulse pGS1 is set to L level, accumulation of a charge generated in the photoelectric conversion unit 201 is started.

Subsequently, at Time T27, a driving pulse pGS2 is set at H level, and the second transferring unit 212 is set to on-state. At Time T2, the driving pulse pGS2 is set at L level, and the second transferring unit 212 is set to off-state.

Thus, the transfer of a charge generated in the photoelectric conversion unit 201 during Period T1-T2 to the second charge storing unit 213 in all the pixels at a time is completed.

After Time T2, in response to the driving pulse pGS2 being set at L level, accumulation of a charge generated in the photoelectric conversion unit 201 is started.

Subsequently, at Time T28, the driving pulse pOFD is set at H level, and the OFD transistor 211 is set to on-state. At Time T3, the driving pulse pOFD is set at L level, and the OFD transistor 211 is set to off-state.

This causes the charge generated in the photoelectric conversion unit 201 during Period T2-T3 to be discharged to the power source Vdd.

Note that an operation for outputting a signal for forming the n-th frame image is performed during Period T2-T4 as described above.

Note that Period ΔT1 and Period ΔT2 have a ratio of 1:4, and ΔT1 is shorter than ΔT2.

In the following description, Period ΔT1 will be referred to as a short accumulation period, and Period ΔT2 will be referred to as a long accumulation period.

In this embodiment, a signal corresponding to the charge accumulated during Period ΔT1 will be treated as a short-second signal, and a signal corresponding to a charge obtained by adding the charge accumulated during Period ΔT1 and the charge accumulated during Period ΔT2 in the FD 205 will be treated as a long-second signal.

A specific output operation in this embodiment is the same as the first output operation in FIG. 4B, and therefore a description thereof will be omitted.

Note that when the output operation is performed in this embodiment, first, a charge in the first charge storing unit 203 that stores the charge generated during the short accumulation period is transferred to the FD 205.

A signal corresponding to the charge PDn(1) transferred to the FD 205 is output to the column circuit 105 to be stored therein.

Subsequently, a charge in the second charge storing unit 213 that stores the charge accumulated during the long accumulation period is transferred to the FD 205.

A signal corresponding to the charge obtained by adding the charge PDn(1) and the charge PDn(2) transferred to the FD 205 is output to the column circuit 105 to be stored therein.

With such a configuration, the dynamic range can be further expanded compared with the first embodiment.

The following description will illustrate the reason that the charge during Period ΔT1, which is the short charge accumulation period, is transferred to the FD 205 before the charge during Period ΔT2, which is the long charge accumulation period, is transferred.

This is because the FD 205 might be saturated if the charge generated during Period ΔT2, which is the long accumulation period, is transferred to the FD 205 first.

On the other hand, the possibility of saturation is reduced if the charge generated during Period ΔT1, which is the short accumulation period, is transferred to the FD 205 first.

In addition, if the charge generated during Period ΔT2 is transferred to the FD 205 first, in order to acquire a signal that is obtained when the charge generated during Period ΔT1 is transferred to the FD 205, a signal corresponding to the charge during Period ΔT2 (S read) needs to be subtracted from a signal corresponding to the charge during Period ΔT1+Period ΔT2 (L read) in the following-stage circuit.

In such a case, part of optical shot noise corresponding to, in addition to the signal corresponding to the charge during Period ΔT1, a signal during Period ΔT1+Period ΔT2 remains.

Accordingly, a signal noise component is increased compared with a case in which only a signal corresponding to the charge during Period ΔT1 is output, and the S/N ratio is decreased.

Note that an example in which the charge transferred to the first charge storing unit 203 and the charge transferred to the second charge storing unit 213 have a ratio of 1:4 has been described above. However, the ratio is not limited to this example and may be selected freely under the condition where Period ΔT1 is shorter than Period ΔT2.

In addition, three or more charge storing units may be used to store charges during a long accumulation period, a short accumulation period, and an intermediate accumulation period, for example.

The same applies to the following embodiments.

### Third Embodiment

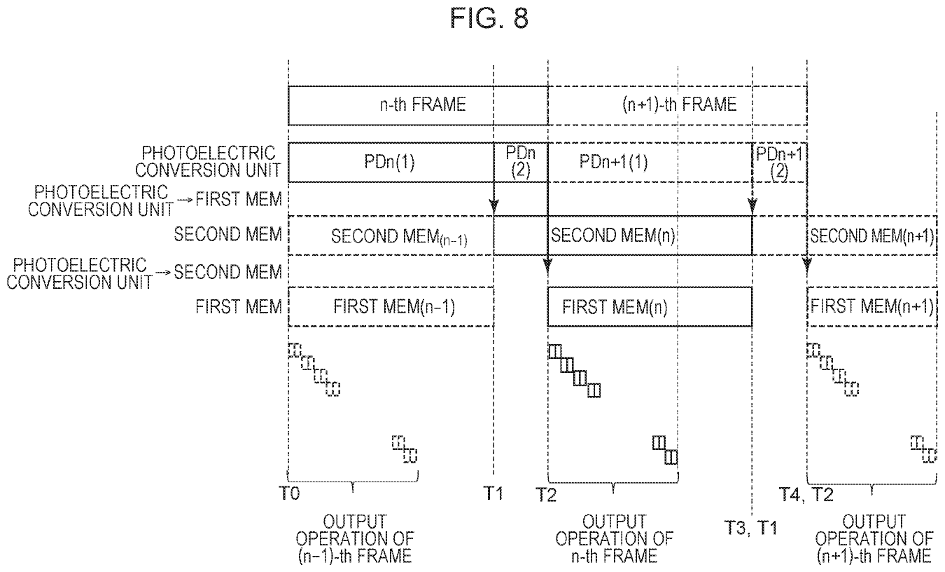

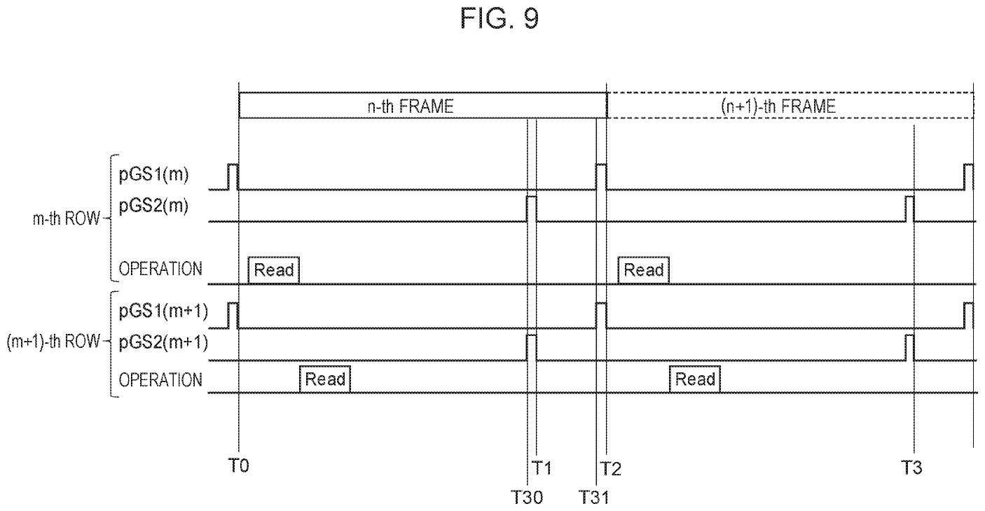

A method for driving an imaging apparatus according to this embodiment will be described with reference to FIGS. 8 and 9.

The circuit configuration of the imaging apparatus and operations of transistors other than those in the pixel circuit are the same as those in the first embodiment, and therefore a description thereof will be omitted.

This embodiment differs from the second embodiment in that a charge during the long accumulation period is transferred first and a charge during the short accumulation period is transferred later in charge transfer from the photoelectric conversion unit 201 to the charge storing units.

That is, in this embodiment, an operation for transferring the charge during the short accumulation period to one of the charge storing units (first charge storing unit) is performed in the state where the charge during the long accumulation period is stored in the other charge storing unit (second charge storing unit).

In this embodiment, the following description will be given focusing on the difference from the second embodiment.

FIG. 8 is a driving conceptual diagram illustrating a method for driving the imaging apparatus according to this embodiment.

At Time T0, a period corresponding to an n-th frame starts. At Time T0, accumulation of a charge generated in the photoelectric conversion unit 201 is started.

At this time, the second charge storing unit 213 stores a charge (PDn−1(1)) for generating an (n−1)-th frame image, and the first charge storing unit 203 stores a charge (PDn−1(2)) for generating the (n−1)-th frame image.

Signals corresponding to the charges stored in the respective charge storing units in pixels in each pixel row during Period T0-T1 are output sequentially in each row.

At Time T1, a charge PDn(1) generated in the photoelectric conversion unit 201 during Period T0-T1 is transferred to the second charge storing unit 213 in all the pixels at a time.

Then, accumulation of a charge generated in the photoelectric conversion unit 201 for which the charge transfer has been completed is started.

At Time T2, a charge PDn(2) generated in the photoelectric conversion unit 201 during Period T1-T2 is transferred to the first charge storing unit 203 in all the pixels at a time.

Note that the above transfer is performed in the state where the charge PDn(1) transferred at Time T1 is stored in the second charge storing unit 213.

In addition, the transfer of charge for generating an n-th frame image is completed at Time T2.

Accordingly, at Time T2, the period corresponding to an (n+1)-th frame starts, and accumulation of a charge generated in the photoelectric conversion unit 201 is started.

Note that the length of Period T0-T1 is longer than the length of Period T1-T2.

During Period T2-T3, signals corresponding to the charges PDn(1) and PDn(2) stored in the respective charge storing units are output sequentially in each row to the outside of the pixel.

Next, timing of actual driving pulses for realizing the above driving will be described with reference to FIG. 9.

In the description of FIG. 9, at Time T0, in response to a driving pulse pGS1 being set at L level, the first transferring unit 202 is set to off-state, and the photoelectric conversion unit 201 starts accumulation of a charge corresponding to incident light.

During Period T0-T1, a charge is accumulated in the photoelectric conversion unit 201. At the same time, an operation for outputting a signal for generating the (n−1)-th frame image is performed.

At Time T30, a driving pulse pGS2 is set at H level, and the second transferring unit 212 is set to on-state. At time T1, the driving pulse pGS2 is set at L level, and the second transferring unit 212 is set to off-state.

During Period T30-T1, the charge PDn(1) generated in the photoelectric conversion unit 201 during Period T0-T1 is transferred to the second charge storing unit 213.

At Time T31, the driving pulse pGS1 is set at H level, and the first transferring unit 202 is set to on-state. At time T2, the driving pulse pGS1 is set at L level, and the first transferring unit 202 is set to off-state.

During Period T31-T2, the charge PDn(2) generated in the photoelectric conversion unit 201 during Period T1-T2 is transferred to the first charge storing unit 203.

Thus, the period corresponding to the n-th frame image ends.

Subsequently, a period corresponding to an (n+1)-th frame image starts.

During Period T2-T3, a charge is accumulated in the photoelectric conversion unit 201. At the same time, an operation for outputting a signal for generating the n-th frame image is performed.

Period T0-T1 (Period ΔT1) and Period T1-T2 (Period ΔT2) have a ratio of 4:1, and Period ΔT2 is shorter than Period ΔT1.

In the following description, Period ΔT2 will be referred to as a short accumulation period, and Period ΔT1 will be referred to as a long accumulation period.

In this embodiment, the charge accumulated in the photoelectric conversion unit 201 during the long accumulation period is transferred to the second charge storing unit 213, and then the charge accumulated in the photoelectric conversion unit 201 during the short accumulation period is transferred to the first charge storing unit 203.

Note that as a specific output operation in this embodiment, the same operation as the first output operation in FIG. 4B is performed.

As in the second embodiment, also in this embodiment, when the first output operation is performed, a charge in the first charge storing unit 203 that stores the charge generated during the short accumulation period is preferably transferred first to the FD 205, and then a charge in the second charge storing unit 213 that stores the charge generated during the long accumulation period is preferably transferred to the FD 205.

With the configuration in which the charge during the long accumulation period is transferred first to the first charge storing unit 203, and then the charge during the short accumulation period is transferred to the second charge storing unit 213 as in this embodiment, output is enabled even in a case in which a frame output operation is not performed at a high speed when a global electronic shutter operation is performed. The reason for this will be described as follows.

If transfer at a time from the photoelectric conversion unit 201 to the charge storing units is performed before transfer from the charge storing units to the FD 205 is completed, accumulation periods corresponding to the charges accumulated in the charge storing units may vary.

That is, it is necessary to complete an operation for outputting a signal for generating an image of the preceding frame before performing a transferring operation from the photoelectric conversion unit 201 to the charge storing units.

In this case, if the charge during the short accumulation period is transferred first to the first charge storing unit 203, it is necessary to have completed charge transfer from the first charge storing unit 203 to the FD 205 and the operation for outputting the signal.

Accordingly, it is necessary to increase at least one of a charge transferring speed and a signal outputting speed.

In addition, if it is not possible to increase at least one of the charge transferring speed and the signal outputting speed, it is necessary to provide an OFD period as in the second embodiment. If the OFD period is provided, the frame rate may be decreased.

On the other hand, by transferring the charge corresponding to the long accumulation period first when a transferring operation from the photoelectric conversion unit 201 to the charge storing units is performed, there is much time to spare when an output period in the period corresponding to the image of the preceding frame is overlapped with an accumulation period of the photoelectric conversion unit in the period corresponding to the image of the current frame. Accordingly, an electronic shutter operation is enabled without providing the OFD period or increasing the charge transferring speed.

In addition, since the OFD period does not have to be provided, almost all of the periods corresponding to the images of the respective frames can be used as the accumulation period of the photoelectric conversion unit. This may increase the S/N ratio at a low illuminance.

In addition, since the charge corresponding to the short accumulation period is transferred first from the charge storing unit to the FD 205 also in this embodiment, the same effects as those in the second embodiment can be obtained.

Although an example in which the signal corresponding to the long accumulation period and the signal corresponding to the short accumulation period have a ratio of 4:1 has been described above, the ratio is not limited to this example and may be selected freely as long as the length of the long accumulation period differs from the length of the short accumulation period.

### Fourth Embodiment

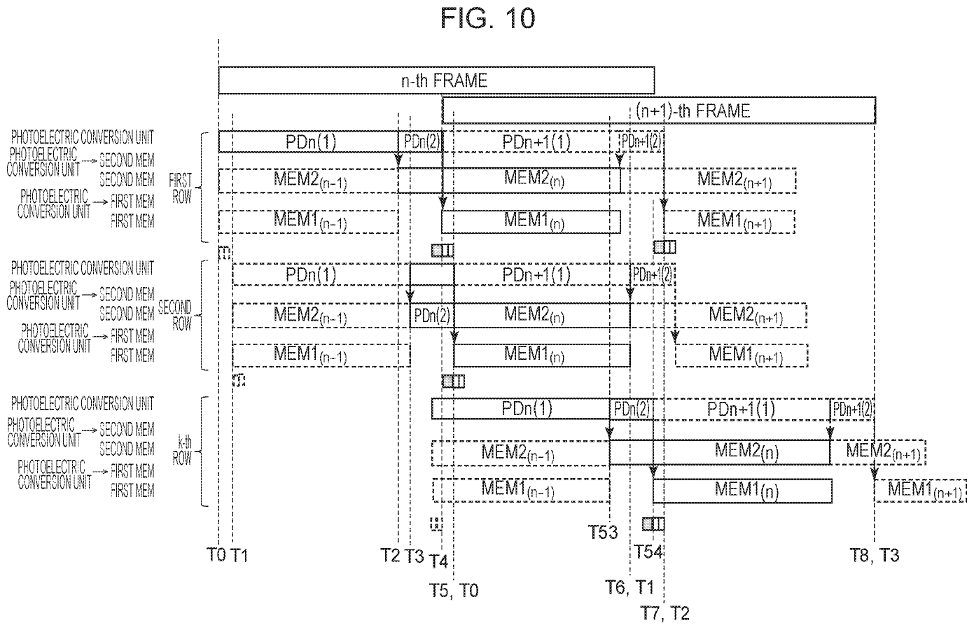

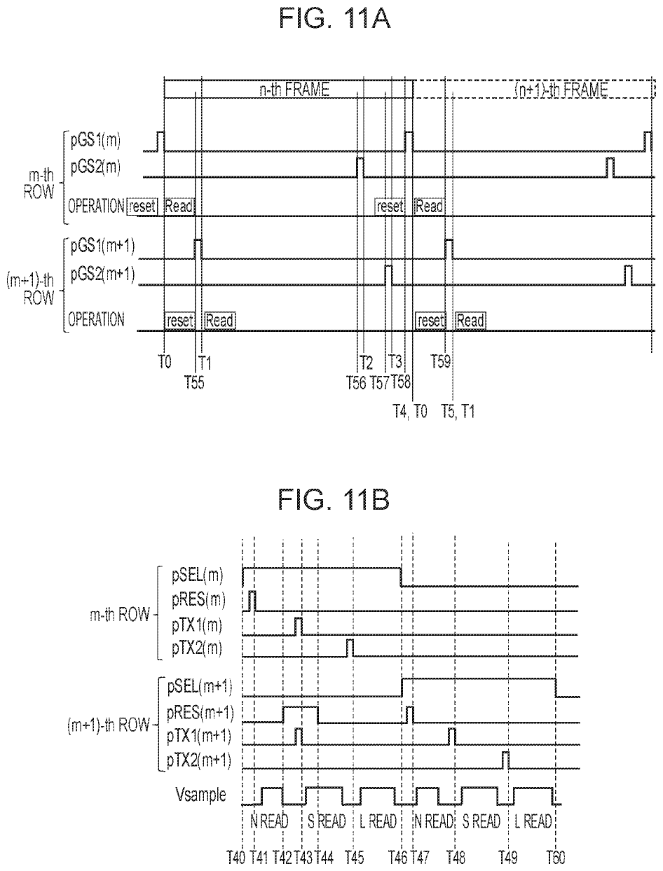

A method for driving an imaging apparatus according to this embodiment will be described with reference to FIGS. 10 and 11A and 11B.

FIG. 10 is a driving conceptual diagram illustrating the method for driving the imaging apparatus according to this embodiment.

This embodiment differs from the third embodiment in that a rolling accumulation operation is performed.

That is, in this embodiment, charge accumulation of the photoelectric conversion unit is started sequentially in each pixel row.

This embodiment also differs from the third embodiment in that a reset operation of a charge storing unit is performed.

That is, in this embodiment, a reset operation is performed in one of the charge storing units (first charge storing unit) by simultaneously setting the third transferring unit and the reset transistor to on-state before a charge is transferred to the one of the charge storing units.

In FIG. 10, Period T0-T54 is a period corresponding to an n-th frame image, and Period T5-T7 is a period corresponding to an (n+1)-th frame image.

The following description will be given by using a first pixel row and a second pixel row.

Note that the period corresponding to the (n+1)-th frame image may start after charge transfer from the photoelectric conversion unit 201 in all pixel rows to the charge storing units is completed in the period corresponding to the n-th frame image.

The period corresponding to the n-th frame image starts at Time T0. At Time T0, accumulation of a charge generated in the photoelectric conversion units in the first row is started. At Time T1, accumulation of a charge in the photoelectric conversion units in the second row is started.

At Time T2, a charge PDn(1) generated in the photoelectric conversion units 201 in the first row during Period T0-T2 is transferred to the second charge storing units 213 in the first row to be stored in the second charge storing units 213 in the first row.

Upon completion of charge transfer, accumulation of a charge generated in the photoelectric conversion units 201 in the first row is started.

Subsequently, at Time T3, a charge PDn(1) generated in the photoelectric conversion units 201 in the second row during Period T1-T3 is transferred to the second charge storing units 213 to be stored in the second charge storing units 213.

Upon completion of charge transfer, accumulation of a charge generated in the photoelectric conversion units 201 in the second row is started.

At Time T4, a charge PDn(2) generated in the photoelectric conversion units 201 in the first row during Period T2-T4 is transferred to the first charge storing units 203 to be stored in the first charge storing units 203.

Subsequently, the charge PDn(1) stored in the second charge storing units 213 in the first row and the charge PDn(2) stored in the first charge storing units 203 are transferred to the FDs 205.

Upon completion of charge transfer, accumulation of a charge for generating the (n+1)-th frame image is started in the photoelectric conversion units 201 in the first row.

At Time T5, a charge PDn(2) accumulated in the photoelectric conversion units 201 in the second row during Period T3-T5 is transferred to the first charge storing units 203 to be stored in the first charge storing units 203.

Subsequently, a charge PDn(1) stored in the second charge storing units 213 in the second row and the charge PDn(2) stored in the first charge storing units 203 are transferred to the FDs 205.

Upon completion of charge transfer, accumulation of a charge in the (n+1)-th frame is started in the photoelectric conversion units 201 in the second row.

Subsequently, the transfer of the accumulated charge from the photoelectric conversion units 201 to the second charge storing units 213, the transfer of the accumulated charge from the photoelectric conversion units 201 to the first charge storing units 203, and transfer from the respective charge storing units to the FDs 205 are performed sequentially in each row.

Next, FIGS. 11A and 11B illustrate examples of specific driving pulses for realizing the operation in FIG. 10, and the operation of the imaging apparatus will be described with reference to FIGS. 11A and 11B.

Between Time T0 and Time T1, an operation for outputting a signal for generating the (n−1)-th frame image in the m-th row is performed. Details of the output operation in the m-th row will be described later with reference to FIG. 11B.

At Time T55, a driving pulse pGS1(m+1) is set at H level, and the first transferring units 202 are set to on-state. At Time T1, the driving pulse pGS1(m+1) is set at L level from H level, and the first transferring units 202 are set to off-state.

Through this operation, the transfer of a charge for generating the (n−1)-th frame image from the photoelectric conversion units 201 in the (m+1)-th row to the first charge storing units 203 is completed.

At Time T56, a driving pulse pGS2(m) is set at H level, and the second transferring units 212 are set to on-state. At Time T2, the driving pulse pGS2(m) is set at L level, and the second transferring units 212 are set to off-state.

Through this operation, a charge for generating the n-th frame image, the charge being generated in the photoelectric conversion units 201 in the m-th row during Period T0-T2, is transferred to the second charge storing units 213 in the m-th row.

At Time T57, a driving pulse pGS2(m+1) is set at H level, and the second transferring units 212 are set to on-state. At Time T3, the driving pulse pGS2(m+1) is set at L level, and the second transferring units 212 are set to off-state.

Through this operation, a charge for generating the n-th frame image, the charge being generated in the photoelectric conversion units 201 in the m-th row during Period T1-T3, is transferred to the second charge storing units 213 in the (m+1)-th row.

At Time T58, a driving pulse pGS1(m) is set at H level, and the first transferring units 202 are set to on-state. At Time T4, the driving pulse pGS1(m) is set at L level, and the first transferring units 202 are set to off-state.

Through this operation, a charge for generating the n-th frame image, the charge being accumulated in the photoelectric conversion units 201 in the m-th row during Period T2-T4, is transferred to the first charge storing units 203 in the m-th row.

At Time T59, the driving pulse pGS1(m+1) is set at H level, and the first transferring units 202 are set to on-state. At Time T5, the driving pulse pGS1(m+1) is set at L level, and the first transferring units 202 are set to off-state.

Through this operation, a charge for generating the n-th frame image, the charge being generated in the photoelectric conversion units 201 in the (m+1)-th row during Period T3-T5, is transferred to the first charge storing units 203 in the (m+1)-th row.

After Period T4, the output operation is performed in the m-th row. After Period T5, the output operation is performed in the (m+1)-th row.

In addition, Period T0-T2 (Period ΔTL) is longer than Period T2-T4 (Period ΔTS), and Period ΔTL and Period ΔTS have a ratio of 4:1.

In the following description, Period ΔTL corresponds to the long accumulation period, and Period ΔTS corresponds to the short accumulation period.

In this embodiment, a charge storing unit to which a charge accumulated in the photoelectric conversion unit 201 during the short accumulation period is to be transferred is reset before the charge is transferred.

For example, in the m-th row, in this embodiment, the first charge storing units 203 in the m-th row are reset during Period T2-T4 before the charge is transferred from the photoelectric conversion units 201 to the first charge storing units 203 at Time T4.

Note that the second charge storing units 213 to which a charge accumulated in the photoelectric conversion units 201 during Period ΔTL is to be transferred may be reset before the charge is transferred.

Next, an output operation in the m-th row and the (m+1)-th row and a reset operation in the charge storing units in the (m+1)-th row will be described with reference to FIG. 11B.

First, the output operation in the m-th row and the (m+1)-th row will be described. In the m-th row, the above-described first output operation is performed during Period T40-T46.

Similarly, in the (m+1)-th row, the above-described first output operation is performed during Period T46-T60.

Next, the reset operation in the second charge storing units 213 in the (m+1)-th row will be described. At Time T42, pRES(m+1) is set at H level. At Time T44, off-state is set.

Thus, the reset transistors are set to on-state during Period T42-T44.

During Period T42-T43, which is included in Period T42-T44, pTX1(m+1) is set at H level. At Time T43, pTX1(m+1) is set at L level.

Through this operation, a charge stored in the first charge storing units 203 is discharged. The charge stored at this time is due to dark current or light shielding failure and is different from a charge transferred from the photoelectric conversion units 201 by setting the second transferring units 212 to on-state.

Then, after Time T44, the first output operation is performed in the (m+1)-th row.

As in the second embodiment, a stored charge corresponding to the short accumulation period is transferred first from charge storing units to the FDs 205 in FIG. 11B.

Accordingly, as in the second embodiment, an effect of preventing saturation of the FD 205 and an effect of increasing the S/N ratio of a signal corresponding to a charge generated during the short accumulation period can be obtained.

In addition, in FIG. 11A, as in the third embodiment, a charge corresponding to the long accumulation period may be transferred first from the photoelectric conversion units 201 to the second charge storing units 213, and then a charge corresponding to the short accumulation period may be transferred from the photoelectric conversion units 201 to the first charge storing units 203.

Thus, in a case of a rolling shutter operation, almost within a reading period for a single row, the charge corresponding to the short accumulation period may be transferred from the photoelectric conversion units 201 to the first charge storing units 203, and the transfer from the first charge storing units 203 to the FDs 205 can be performed.

As in this embodiment, by performing a reset operation of the first charge storing units 203 before a charge is transferred from the photoelectric conversion units 201 to the first charge storing units 203 that stores the charge corresponding to the short accumulation period, the influence of unnecessary charge generated by light shielding failure, dark current, or the like can be suppressed.

In addition, since the influence of light shielding failure is obvious during the short accumulation period where the signal is low, the present invention is more effective in such a case. However, the same effect can be obtained by performing a reset operation in the first charge storing units 203 before a charge is transferred from the photoelectric conversion units 201 to the second charge storing units 213 that store a charge corresponding to the long accumulation period.

The reset operation in this embodiment can suppress the influence of unnecessary charge generated by dark current or the like also in the first to third embodiments.

### Fifth Embodiment

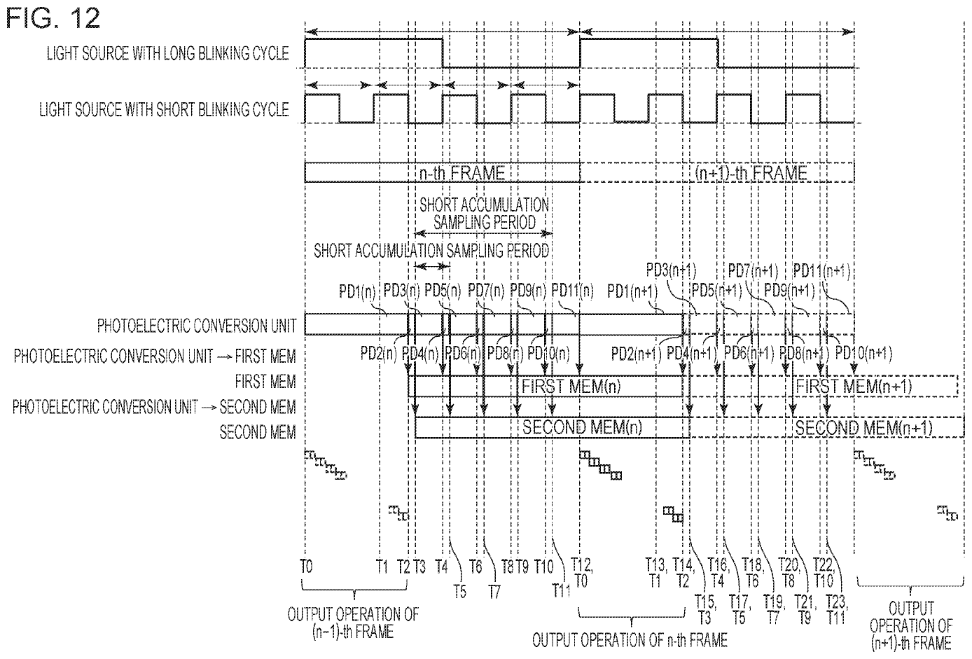

A method for driving an imaging apparatus according to this embodiment will be described with reference to FIG. 12.

The circuit configuration of the imaging apparatus excluding pixels and operations of transistors other than those in the pixel circuit are the same as those in the third embodiment, and therefore a description thereof will be omitted.

FIG. 12 is a conceptual diagram illustrating a charge generated in the photoelectric conversion unit in this embodiment, charges stored in the charge storing units, and output operations thereof.

This embodiment differs from the third embodiment in that a charge is transferred from the photoelectric conversion unit 201 to the charge storing units a plurality of times without resetting the charge storing units in this embodiment.

In FIG. 12, at Time T0 during a period corresponding to an n-th frame image, charge accumulation is started in the photoelectric conversion unit 201.

At Time T2, a charge PD1(n) generated in the photoelectric conversion unit 201 during Period T0-T2 is transferred to the first charge storing unit 203. After Time T2, charge accumulation is started in the photoelectric conversion unit 201.

Subsequently, at Time T3, a charge PD2(n) generated in the photoelectric conversion unit 201 during Period T2-T3 is transferred to the second charge storing unit 213.

After Time T3, charge accumulation is started in the photoelectric conversion unit 201.

At Time T4, a charge PD3(n) generated in the photoelectric conversion unit 201 during Period T3-T4 is transferred to the first charge storing unit 203.

After Time T4, charge accumulation is started in the photoelectric conversion unit 201.

Note that an operation for transferring a charge accumulated in the photoelectric conversion unit 201 to any of the charge storing units is referred to as a sampling operation.

In addition, Period T3-T4 (referred to as Period ΔTL) is longer than Period T2-T3 (referred to as Period ΔTS).

Similarly, Period T0-T2 (referred to as Period ΔTLL) is longer than Period ΔTS.

In the subsequent processing, a sampling operation during Period ΔTL and a sampling operation during Period ΔTS are repeatedly performed until Time T12.

During Period T12-T14, a sampling operation during Period ΔTLL in an (n+1)-th frame is performed.

In this embodiment, sampling during the long accumulation period (Period ΔTL, Period ΔTLL) is performed six times, and the sampling operation during the short accumulation period (ΔTS) is performed five times. The sampling operation during the long accumulation period and the sampling during the short accumulation period are alternately performed.

From Time T12, an output operation in the n-th frame is performed.

Note that a period between a single time of sampling operation to the end of the following sampling operation is referred to as a sampling cycle, and a period from the start of a sampling operation to the end of the sampling operation within a frame is referred to as a sampling period.

The effects of this embodiment will be described. Since the sampling cycle and the sampling period differ from each other, it is possible to suppress the flicker phenomenon of light sources with various cycles.

FIG. 12 illustrates a light source with a long blinking cycle by using a rectangular wave.

The blinking cycle is almost the same as the frame cycle. In a case in which the sampling period during the short accumulation period is short, for example, in a case in which Period T9-T11 is set as the sampling period, a sampling operation is performed only during a period in which the light source having a long blinking cycle illustrated in the example is turned off. Accordingly, there is a possibility that lighting of the light source is not recognized.

Specifically, for example, if a red traffic light is on in the bright day time, in imaging with a short exposure period, there is a possibility of erroneous detection that the light is not on.

In addition, due to a phase shift in the light source blinking, the light source blinks in a moving image. This decreases the image quality.

In contrast, in this embodiment, the sampling period is set to Period T2-T11. The length of Period T2-T11 is longer than half the length of Period T0-T12, which corresponds to a single frame.

This makes it possible to recognize the lighting state of a blinking light source during Period T2-T4.

That is, even if a phase shift occurs in the light source, the lighting state of the light source can be accurately recognized.

Although a light source with a long blinking cycle has been described above, a light source with a blinking cycle that is shorter than double the sampling period during the short accumulation period may be used.

As an example, a light source with a short blinking cycle is illustrated in FIG. 12 by using a rectangular wave. By making the sampling cycle short, a light source having a shorter cycle may be used.

Examples of a blinking light source typically include a fluorescent lamp using a commercial power supply, a traffic light, and the like.

The commercial power supply has various frequencies depending on the area, such as 50 Hz and 60 Hz. For an LED electric bulletin board or the like, the frequency is not fixed according to type in some cases. Accordingly, since light sources with various cycles can be used, flicker can be reduced for various subjects.

In addition, the necessity for matching the phases of the blinking of a light source and short-period exposure is reduced. Thus, a lighting detecting unit that detects blinking of a light source is unnecessary.

Furthermore, the phase of blinking of the light source and the phase of an exposure operation of the imaging apparatus do not have to correspond to each other. Thus, the circuit configuration is simplified.

As a result, an inexpensive imaging apparatus is realized.

In this embodiment, the first charge storing unit 203 stores a signal charge corresponding to the long accumulation period, and the second charge storing unit 213 stores a charge corresponding to the short accumulation period.

However, the first charge storing unit 203 may store the short accumulation period, and the second charge storing unit 213 may store the long accumulation period.

The present invention is not limited to the above embodiments, and various modifications and alternations are possible without departing from the spirit and range of the present invention.

1. A method for driving an imaging apparatus including a plurality of pixels in a matrix, wherein the matrix includes a plurality of pixel rows, wherein each of the pixel rows includes a respective plurality of pixels, and wherein the pixels each include, respectively,
a photoelectric conversion unit,
at least two charge storing units configured to store a first charge and a second charge generated in the photoelectric conversion unit,
a first transferring unit configured to transfer the first charge generated in the photoelectric conversion unit from the photoelectric conversion unit to a first charge storing unit,
a second transferring unit configured to transfer the second charge generated in the photoelectric conversion unit from the photoelectric conversion unit to a second charge storing unit,
a floating diffusion to which the first charge stored in the first charge storing unit and the second charge stored in the second charge storing unit are transferred,
a third transferring unit configured to transfer the first charge from the first charge storing unit to the floating diffusion, and
a fourth transferring unit configured to transfer the second charge from the second charge storing unit to the floating diffusion, the method comprising:
by, sequentially by row, turning on the first transferring unit and the second transferring unit in the respective plurality of pixels in each row, causing the first charge storing unit to store the first charge generated in the photoelectric conversion unit during a certain period and the second charge storing unit to store the second charge generated in the photoelectric conversion unit during a different period, and
then setting the third transferring unit to on-state to transfer the first charge to the floating diffusion, and then, in a state where the first charge is stored in the floating diffusion, setting the fourth transferring unit to on-state.

2. The method for driving an imaging apparatus according to claim 1, wherein, a first charge accumulation period of the photoelectric conversion unit for the first charge to be transferred from the photoelectric conversion unit to the first charge storing unit by once setting the first transferring unit to on-state is shorter than a second charge accumulation period of the photoelectric conversion unit for the second charge to be transferred from the photoelectric conversion unit to the second charge storing unit by once setting the second transferring unit to on-state.

3. The method for driving an imaging apparatus according to claim 2, wherein, when the first charge generated in the photoelectric conversion unit during the certain period is caused to be stored in the first charge storing unit and the second charge generated in the photoelectric conversion unit during the different period is caused to be stored in the second charge storing unit, the second charge is stored in the second charge storing unit, and then the first charge is stored in the first charge storing unit.

4. The method for driving an imaging apparatus according to claim 1, wherein, when the first charge generated in the photoelectric conversion unit during the certain period is caused to be stored in the first charge storing unit and the second charge generated in the photoelectric conversion unit during the different period is caused to be stored in the second charge storing unit, at least one of the first transferring unit and the second transferring unit is set to on-state a plurality of times.

5. The method for driving an imaging apparatus according to claim 4, wherein, when the first charge generated in the photoelectric conversion unit during the certain period is caused to be stored in the first charge storing unit and the second charge generated in the photoelectric conversion unit during the different period is caused to be stored in the second charge storing unit, the first transferring unit and the second transferring unit are alternately set to on-state.

6. The method for driving an imaging apparatus according to claim 1, wherein, before the second transferring unit is set to on-state, the charge stored in the second charge storing unit is reset.

7. The method for driving an imaging apparatus according to claim 1, wherein, before the first transferring unit is set to on-state, the charge stored in the first charge storing unit is reset.

8. The method for driving an imaging apparatus according to claim 1, wherein, in a plurality of pixel rows, the first transferring units or the second transferring units included in the pixels in each of the pixel rows are sequentially set to on-state for each pixel row.

9. The method for driving an imaging apparatus according to claim 1, wherein,
each of the pixels includes an overflow drain transistor configured to reset the photoelectric conversion unit, and
a charge accumulation period of the photoelectric conversion unit starts upon the overflow drain transistor being set to on-state.

10. The method for driving an imaging apparatus according to claim 1, wherein, sequentially by row, turning on the first transferring unit and the second transferring unit in the respective plurality of pixels in each row includes:
simultaneously turning on the respective first transferring unit in each of the respective plurality of pixels in the row, and
simultaneously turning on the respective second transferring unit of each of the respective plurality of pixels in the row.

11. The method for driving an imaging apparatus according to claim 1, wherein, sequentially by row, turning on the first transferring unit and the second transferring unit in the respective plurality of pixels in each row includes:
turning off the respective first transferring unit and the respective second transferring unit in each of the respective plurality of pixels in the row before turning on the respective first transferring unit and the respective second transferring unit in the respective plurality of pixels in another row.

12. A method for driving an imaging apparatus including a plurality of pixels in a matrix, wherein the matrix includes a plurality of pixel rows, wherein each of the pixel rows includes a respective plurality of pixels, and wherein the pixels each include, respectively,
a photoelectric conversion unit,
at least two charge storing units configured to store a first and a second charge generated in the photoelectric conversion unit,
a first transferring unit configured to transfer the first charge generated in the photoelectric conversion unit from the photoelectric conversion unit to a first charge storing unit,
a second transferring unit configured to transfer the second charge generated in the photoelectric conversion unit from the photoelectric conversion unit to a second charge storing unit,
a floating diffusion to which the first charge stored in the first charge storing unit and the second charge stored in the second charge storing unit are transferred,
a third transferring unit configured to transfer the first charge from the first charge storing unit to the floating diffusion, and
a fourth transferring unit configured to transfer the second charge from the second charge storing unit to the floating diffusion, the method comprising:
by, sequentially by row, turning on the first transferring unit and the second transferring unit in the plurality of pixels in each row, causing the first charge storing unit to store the first charge generated in the photoelectric conversion unit during a certain period and the second charge storing unit to store the second charge generated in the photoelectric conversion unit during a different period,
and then adding, in the floating diffusion, the first charge stored in the first charge storing unit and the second charge stored in the second charge storing unit.

13. A method for driving an imaging apparatus including a plurality of pixels in a matrix, wherein the matrix includes a plurality of pixel rows, wherein each of the pixel rows includes a respective plurality of pixels, and wherein the pixels each include, respectively,
a photoelectric conversion unit,
at least two charge storing units configured to store a first charge and a second charge generated in the photoelectric conversion unit,
a first transferring unit configured to transfer the first charge generated in the photoelectric conversion unit from the photoelectric conversion unit to a first charge storing unit,
a second transferring unit configured to transfer the second charge generated in the photoelectric conversion unit from the photoelectric conversion unit to a second charge storing unit,
a floating diffusion to which the first charge stored in the first charge storing unit and the second charge stored in the second charge storing unit are transferred,
a third transferring unit configured to transfer the first charge from the first charge storing unit to the floating diffusion, and
a fourth transferring unit configured to transfer the second charge from the second charge storing unit to the floating diffusion, the method comprising:
according to a sequence that progresses row by row through each pixel row in the plurality of pixel rows, for each pixel row when the sequence arrives at the pixel row, turning on the first transferring unit and the second transferring unit in the respective plurality of pixels in the pixel row, thereby causing the respective first charge storing unit of each of the plurality of pixels in the pixel row to store the first charge generated in the photoelectric conversion unit during a certain period and the respective second charge storing unit of each of the plurality of pixels in the pixel row to store the second charge generated in the photoelectric conversion unit during a different period, and
then setting the third transferring unit to on-state to transfer the first charge to the floating diffusion, and then, in a state where the first charge is stored in the floating diffusion, setting the fourth transferring unit to on-state.
